(19) United States
(12) Patent Application Publication
(10) Pub. No.: US 2004/0089106 A1
(43) Pub. Date: May 13, 2004

(54) Compact high-torque ratchet wrench

(76) Inventors: Sandra C. Wolfe, Roaring Gap, NC (US); Garrett L. Bryant, Ennice, NC (US); Johnny L. Phillips, Woodlawn, VA (US)

Correspondence Address: WOMBLE CARLYLE SANDRIDGE & RICE, PLLC, P.O. BOX 7037, ATLANTA, GA, 30357-0037, US

(21) Appl. No.: 10/292,113

(22) Filed: Nov. 12, 2002

(51) Int. Cl. B25B 13/00

(52) U.S. Cl. 81/58.3

(57) ABSTRACT

A compact high-torque ratcheting box wrench is disclosed. The ratcheting box wrench includes a wrench housing and a drive member having a front face and a rear face. The drive member is rotatably mounted in the housing and has a nut-receiving or head-receiving aperture therethrough. A drive/ratchet mechanism includes a drive coupling that selectively engages the drive member at a plurality of discrete points that substantially surround the hex-receiving aperture, and thereby prevents rotation of the drive member relative to the housing in a first direction of rotation. The drive/ratchet mechanism also permits substantially free rotation of the drive member relative to the housing in an opposite second direction of rotation. The full circumferential engagement between the drive coupling and the drive member permits the wrench to withstand much greater torsional loads than conventional ratcheting box or socket wrenches, thereby permitting the wrench to be used to both torque and untorque bolts, screws, nuts, and the like at high torque values.

### BACKGROUND

1. Field of the Invention

The invention relates generally to hand tools, and more particularly to ratcheting wrenches and drive/ratcheting mechanisms for wrenches.

2. Discussion of the Prior Art

Manual wrenches are known for tightening and loosening bolts, nuts, screws, pipe fittings, and the like. These wrenches include conventional, non-ratcheting box-end wrenches, open-end wrenches, and combination wrenches. Such wrenches often are sold in sets that include a series of wrenches in graduated sizes that are compatible with a range of standard sizes of bolts, screws, and nuts. While such wrenches are useful when access to a bolt, screw, or nut and clearances around the bolt, screw, or nut are not restrictive, using such wrenches in close quarters can be difficult. On occasion, surrounding obstructions may restrict the range of swing of the handles of such wrenches as the wrenches are used to tighten or loosen bolts, screws, or nuts. Therefore, the available rotation of the bolt-head, screw-head, or nut using the wrench is limited. In such situations, in order to further rotate the bolts, screws, or nuts, the heads of these wrenches must be disengaged from the bolt heads, screw heads, or nuts, the wrenches must be repositioned to another starting position to allow additional rotation of the wrenches and bolts, screws, or nuts, and the wrenches must be reengaged on the bolts, screws, or nuts for further tightening or loosening. This process may have to be repeated many cycles before the bolts, screws, or nuts are sufficiently tightened or loosened. In addition, where surrounding obstructions prevent a wrench handle from swinging at least 60 degrees (the angle between adjacent flats on a hex bolt-head, screw-head, or nut), it may be impossible to accomplish such iterative rotation of the bolt, screw, or nut since the surrounding obstructions may prevent the wrench from being repositioned such that the head of the wrench can be reengaged on the bolt-head, screw-head, or nut.

Ratcheting wrenches are known which are often helpful in such restrictive surroundings. Ratcheting wrenches include internal ratcheting mechanisms that permit the wrenches to be used to apply torque in one direction of rotation. Ratcheting wrenches also permit the wrench handles to be substantially freely reversed in the opposite direction of rotation without applying substantial reverse torque or reverse rotation to the bolt, screw, or nut, thereby permitting the wrench handles to be easily repositioned for additional torque-applying strokes. One common type of ratcheting wrench is the conventional ratcheting socket wrench.

Ratcheting socket wrenches typically include a handle with a housing or head on one end. A main drive member is rotatably mounted in the head or housing, and includes a central axis that is substantially perpendicular to the handle. The housing typically includes an opening including a series of internal gear teeth or splines along its inner wall or edge. These teeth or splines engage mating teeth on a pawl that is pivotally mounted to the main drive member. The pawl and mating teeth are configured such that the pawl prevents rotation of the main drive relative to the head or housing in one direction of rotation. In addition, the pawl is configured to selectively pivot and disengage from the teeth or splines to permit rotation of the main drive relative to the head or housing in an opposite direction of rotation. The main drive typically includes a box member extending outwardly from the wrench head or housing at right angles to the handle. The box member is configured to positively engage a square end of a socket which has a hex-shaped opening in its opposite end for mating engagement with a bolt-head, screw-head, or nut. Socket wrench sets typically include a series of compatible sockets having a graduated range of standard-sized openings for use with bolts, screws, or nuts of various standard sizes.

The ratcheting action of socket wrenches permits wrenches to be advanced in one direction of rotation to tighten or loosen bolts, screws, or nuts, and permits the socket wrench handles to be repositioned for additional rotation of the bolts, screws, or nuts by swinging the handles in the opposite direction without removing the sockets from the bolt heads, screw heads, or nuts. Often, such socket wrenches are configured such that they are reversible, i.e. a dial or button actuator mechanism on the wrenches can be manipulated to reverse the direction of torque application from clockwise to counter-clockwise and vice versa. Accordingly, ratcheting socket wrenches can be iteratively advanced and reversed to tighten or loosen a bolt, screw, or nut in environments which make the use of conventional box-end or open-end wrenches difficult, impractical, or impossible.

One disadvantage of ratcheting socket wrenches is that the wrench heads and engaged sockets necessarily have minimum combined overall heights that sometimes interfere with their use. This minimum combined height is necessary because the box member necessarily extends outwardly from the head or housing of the wrench which itself has a fixed height or thickness, and the socket must be long enough to receive the box member of the wrench at one end and the bolt head, screw head, or nut on the opposite end. Accordingly, sockets for large bolts, screws, or nuts are necessarily taller than sockets for smaller bolts, screws, or nuts. Due to this minimum combined height, a socket wrench cannot be used where the distance between the top of a bolt head, screw head, or nut and an obstruction that is substantially above the bolt head, screw head, or nut is less than the combined height of the wrench head and engaged socket. In such situations, the obstruction prevents the hex end of the socket from being positioned about the bolt head, screw head, or nut that is to be loosened or tightened with the socket wrench.

Another disadvantage of conventional ratcheting socket wrenches is that they are capable of transmitting only a limited amount of torque. Because the engagement between the teeth of the ratchet pawls with the teeth or splines in the housing or drive member typically involves only a few teeth or splines, the teeth or splines of the housing, main drive, or pawl may fail or become damaged when an excessive amount of torque is applied with the wrench. In order to increase the torque capacity of a socket wrench, it is typically necessary to make the wrench head, the splines or teeth in the housing, and the pawl and pawl teeth correspondingly larger to withstand the higher torque, or to construct these members from costly high-strength materials. An increase in the size of the wrench makes restrictive space limitations as discussed above even more problematic.

Another type of ratcheting wrench which is more adaptable to situations where surrounding obstructions permit only limited access to a bolt head, screw head, or nut is a so-called “ratcheting box wrench” or “gear wrench.” Common ratcheting box wrenches may be similar in appearance to combination wrenches that have a conventional box end head on one end of a handle and an open end wrench head on the opposite end of the handle. The box ends of ratcheting box wrenches, however, include internal drive/ratcheting mechanisms which are similar in operation to the drive/ratcheting mechanisms found in ratcheting socket wrenches as described above. Conventional ratcheting box wrenches include a head or housing on the end of a handle. The head or housing is typically at least slightly larger than the head of a standard box-wrench for the same hex size. The head includes a substantially circular aperture configured to receive a drive member. The drive member is substantially ring-shaped, and includes a central opening shaped to matingly receive a hex-shaped bolt head, screw head, or nut. The drive member also typically includes a series of splines or teeth along a substantially cylindrical outer edge or rim. The drive member is supported in the housing such that the drive member can rotate about a central axis in the housing. A conventional pawl having one or more teeth for engagement with a portion of the splines or teeth on the drive member is pivotally mounted in the housing. Like the ratcheting socket wrenches described above, the pawls in conventional ratcheting box wrenches prevent rotation of the drive member in one direction of rotation, but pivot to permit substantially free rotation of the drive member in the opposite direction of rotation. Accordingly, these ratcheting box wrenches permit a bolt, screw, or nut to be rotated by iterative forward and reverse rotation of the wrench handle. Because ratcheting box wrenches do not include an outwardly extending box member and do not require outwardly extending sockets like socket wrenches, conventional ratcheting box wrenches have much smaller overall heights or thicknesses than socket wrenches for any particular hex size. Therefore, ratcheting box wrenches can usually be positioned on a bolt head, screw head, or nut in much tighter confines than a conventional socket wrench/socket combination.

Like socket wrenches, however, conventional ratcheting box wrenches are limited in the amount of torque they can apply before their drive/ratcheting mechanisms become damaged or fail. Like ratcheting socket wrenches, the pawls of these conventional ratcheting box wrenches include only a few teeth that engage only a portion of the splines or teeth on the drive member to prevent rotation of the drive member relative to the housing or head of the wrench as the wrench is used to apply torque. Accordingly, these wrenches are limited in the amount of torque they can produce and safely withstand. For this reason, ratcheting box wrenches typically should not be used to un-torque and remove a bolt, screw, or nut because the required break-away torque often can exceed the torque capacity of the internal ratcheting mechanisms. This is particularly true where a bolt, screw, or nut has seized due to rust, corrosion, contaminants, or the like. Accordingly, ratcheting box wrench manufacturers provide U-shaped, open-end wrench heads on the opposite ends of the wrench handles for the specific purpose of un-torquing bolts, screws, or nuts. Unfortunately, unlike box-end wrench heads that engage every flat on a hex head or nut, open-end wrench heads contact only two of the six flats. As a result, the contact loads between the wrench and the bolt, screw, or nut are much greater for an open-end wrench head, and the applied torque may yield the bolt head, screw head, or nut before the bolt, screw, or nut has broken free. In addition, ratcheting box wrench producers often place warnings on their products and/or their packaging to caution users that the box or gear ends of the wrenches are not designed to be used for un-torquing bolts, screws or nuts, and that only the open end of the wrench is to be used for this purpose. This limitation can be problematic, especially if a user fails to heed these warnings and exceeds the torque limits of the ratcheting box wrench, thereby causing the wrench to break or to be permanently damaged. Also, it is inconvenient to have to use one end of these ratcheting box wrenches to break the bolt, screw, or nut free, and to then have to switch to the gear end of the wrench to take advantage of the ratchet feature to fully remove the loosened bolt, screw, or nut.

Though it is possible to increase the strength of conventional drive/ratcheting mechanisms with conventional pivoting pawls by increasing the size of the teeth on their output/drive members and correspondingly increasing the sizes of their pawls, this necessarily requires a corresponding increase in the overall size of the heads of the stronger wrenches. Such increases in size, however, significantly increase the minimum space required to engage and operate these larger wrenches, thereby limiting their usefulness. Also, increasing the size of the teeth on the output/drive members necessarily requires increasing the angular spacing between adjacent teeth. Because of this increased spacing, the wrench must rotate through a greater angle to cause the pawl to ratchet as the handle is reversed. Where the angle of reverse handle swing is limited by surrounding obstructions, there may be insufficient space to permit such larger wrenches to be used effectively in a ratcheting mode.

Therefore, there is a need for a compact ratcheting wrench that has a higher torque capacity than conventional ratcheting socket and ratcheting box wrenches, and can be used to both torque and untorque bolts, screws, or nuts using a single ratcheting wrench head in circumstances where access to the bolts, screws, or nuts is limited.

### SUMMARY OF THE INVENTION

A high-torque ratcheting box wrench is provided. Unlike conventional ratcheting box wrenches, the wrench is capable of applying a high torque to a bolt, screw, or nut in either a clockwise or counterclockwise direction. This is achieved by providing a drive/ratcheting mechanism having a drive coupling that selectively engages a rotatably mounted drive member at a plurality of discrete points that substantially surround the hex-receiving aperture, and thereby prevents rotation of the drive member relative to the housing in a first direction of rotation. This engagement of the drive/ratchet mechanism substantially around the full circumference of the drive member makes the wrench capable of withstanding much higher torque values than conventional drive wrenches that engage their drive members at only one or a few discrete points on the drive members. The drive/ratchet mechanism also permits substantially free rotation of the drive member in an opposite second direction of rotation. The wrench may be used in a first orientation to apply a clockwise torque, and may be flipped over 180 degrees (about the axis of the handle) to a second orientation to apply a counterclockwise torque.

The ratcheting box wrench includes a housing and an elongated handle having a first end connected to the housing and a second end. A drive member is rotatably mounted in the housing and includes a central aperture therethrough and a drive/ratchet face comprising a plurality of drive teeth. The aperture through the drive member is preferably shaped to receive an object having a substantially hex-shaped cross-section such as a bolt head, screw head, or nut. A ratcheting mechanism includes a substantially ring-shaped drive coupling having a central axis. A drive coupling drive/ratchet face includes a plurality of drive coupling teeth configured for selective meshed engagement with the drive teeth on the drive member. A spring biases the drive coupling against the drive member such that the drive coupling teeth and drive teeth are resiliently held together in meshed engagement. The drive/ratcheting mechanism is configured such that all of the drive coupling teeth and drive teeth meshingly engage each other and thereby prevent rotation of the drive member in the housing in a first direction of rotation, yet permit the drive member to substantially freely rotate in the housing in an opposite second direction of rotation.

The drive member includes a front face and a rear face, and the hex-shaped object such as a bolt head, screw head, or nut can be received in the central aperture of the drive member from either the front face or the rear face. The central aperture in the main drive has a shape that provides a plurality of circumferentially spaced recesses for receiving corners of the hex-shaped object when the object is received in the aperture. The number of circumferentially spaced recesses provided by the shape of the aperture is a multiple of six, such as 6, 12, or 18, for example.

Each of the drive coupling teeth include a substantially planar drive face that is substantially parallel to the central axis of the drive coupling, and a substantially planar slip surface arranged at an acute angle with the substantially planar drive face. Correspondingly, the drive teeth include a substantially planar drive face that is substantially parallel to the central axis of the drive member, and a substantially planar slip surface arranged at an acute angle with the substantially planar drive face. This “saw tooth” ratchet tooth shape causes the drive coupling and drive member to lock in intermeshed engagement as the drive coupling rotates relative to the drive member in a direction that causes the drive faces of the drive coupling teeth and drive teeth to be forced together. The inclined slip surfaces of the drive coupling and drive teeth, on the other hand, interact to cause the drive coupling and drive member to be wedged apart as the drive coupling is rotated in an opposite direction, thereby disengaging the ratchet teeth, and permitting relative rotation between the drive coupling and drive member in this opposite direction of rotation.

The second end of the handle may include a conventional open-end or box end wrench head. The wrench head on the second end of the handle may be sized for use with a hex-shaped bolt head, screw head, or nut that is of the same size as for the ratcheting wrench head. Alternatively, the second end of the handle may include a second ratcheting box wrench head like that described above. In this arrangement, the second ratcheting gear head is may be sized for use with a different size bolt, screw, or nut than the ratcheting box wrench head on the first end of the handle. In another arrangement, the handle may be have a blunt second end.

The ratcheting box wrench may also include a socket adapter that permits the wrench to be used like a conventional socket wrench, but at much higher torque limits. The adapter includes a first end with a hex head configured to be matingly received in the central aperture in the drive member, and a second end with a box member configured to securely engage a square opening in the end of a socket. The hex head is engaged in the central aperture in the drive member from a selected side of the wrench depending on whether torque is to be applied with the adapter and wrench in a clockwise or counterclockwise direction. A socket for a particular size of bolt, screw, or nut is then assembled on the box member on the adapter. The wrench and socket can then be used in a manner similar to a conventional socket wrench to torque or untorque the bolt, screw, or nut as desired.

The handle of the wrench may be rigidly fixed to the housing. Alternatively, the handle may be pivotally mounted to the housing so that the handle can be pivoted relative to the wrench head. This pivoting connection permits the handle to be optimally positioned to avoid obstructions or provide additional clearance for gripping the wrench.

A reading of the following detailed description together with the drawings will provide a more thorough understanding of a compact high-torque ratcheting wrench according to the invention.

### BRIEF DESCRIPTION OF THE DRAWINGS

FIG. 1 is a perspective view of one embodiment of a ratcheting box wrench assembly according to the invention;

FIG. 2 is an exploded perspective view of the ratcheting box wrench assembly shown in FIG. 1;

FIG. 3 is a cross-sectional perspective view of the head portion of the ratcheting box wrench assembly shown in FIGS. 1 and 2 taken along line 3-3 shown in FIG. 1 and shown with a socket adapter connected thereto;

FIG. 4 is a detail perspective view of the body of the ratcheting box wrench assembly shown in FIGS. 1-3;

FIG. 5 is a detail perspective view of the drive member of the ratcheting box wrench assembly shown in FIGS. 1-3;

FIG. 6 is a detail perspective view of the drive coupling of the ratcheting box wrench assembly shown in FIGS. 1-3;

FIG. 7 is a detail perspective view of the biasing member or spring of the ratcheting box wrench assembly shown in FIGS. 1-3;

FIG. 8 is a detail perspective view of the front cover plate of the ratcheting box wrench assembly shown in FIGS. 1-3;

FIG. 9 is a detail perspective view of the back cover plate of the ratcheting box wrench assembly shown in FIGS. 1-3;

FIG. 10 is a detail perspective view of a socket adapter for use with the ratcheting box wrench shown in FIG. 1 as shown in FIGS. 2 and 3; and

FIG. 11 is a perspective view of a second embodiment of a ratcheting box wrench having a handle pivotally connected to the box wrench housing;

FIG. 12 is a perspective view of another embodiment of a ratcheting box wrench with a pivotally-connected handle;

FIG. 13 is a perspective exploded view of the ratcheting box wrench of FIG. 12 paired with a special socket;

FIG. 14 is a perspective view of the wrench and special socket of FIG. 13 with the socket engaged in the wrench;

FIG. 15 is a partial cross sectional view of the wrench and special socket of FIGS. 13 and 14 engaged over a threaded shank and nut; and

FIG. 16 is a partial cross sectional view of a conventional socket wrench and socket engaged over a threaded shank and nut.

### DETAILED DESCRIPTION

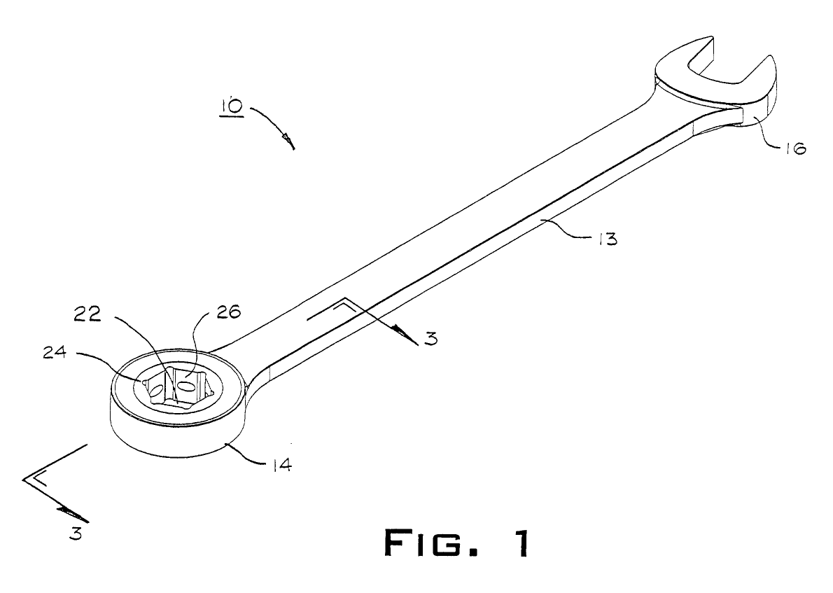

FIG. 1 shows one embodiment of a compact high-torque ratcheting box wrench 10. Wrench 10 includes ratcheting head 14 on one end of handle 13. An open-end wrench head 16 or box-end wrench head (not shown) may optionally be provided on the opposite end of the handle 13 as shown in FIG. 1. The ratcheting head 14 includes a hex-receiving aperture 22. The hex-receiving aperture 22 is sized to fittingly receive a hex-shaped bolt head, screw head, or nut of a selected size. The aperture 22 shown in the figures is substantially hexagonally shaped and includes six rounded reliefs 24 at six “points” or corners. As will be apparent to those of ordinary skill in the art, other shapes of apertures 22 may also be used to adapt the wrench 10 to objects having other shapes. Further, the aperture 22 may be substantially like the opening in a conventional 12-point box wrench. The aperture 22 may alternatively include a greater number of evenly spaced points in multiples of six. For high-torque applications, however, six points may be preferable to avoid undesirable deformation of a hex-shaped bolt head, screw head, or nut during torquing or untorquing with the wrench 10.

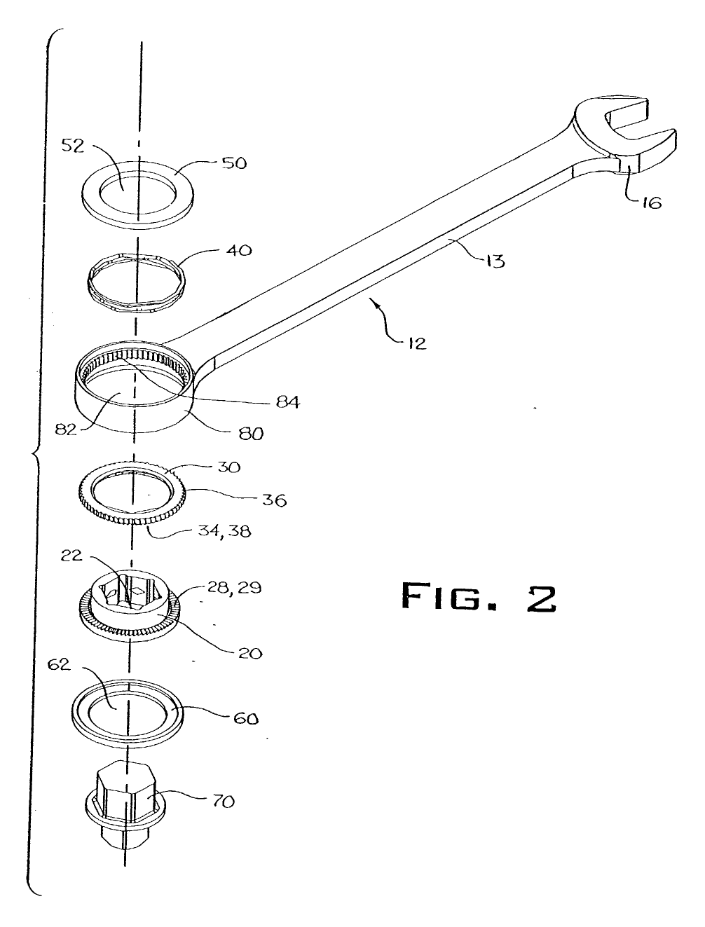

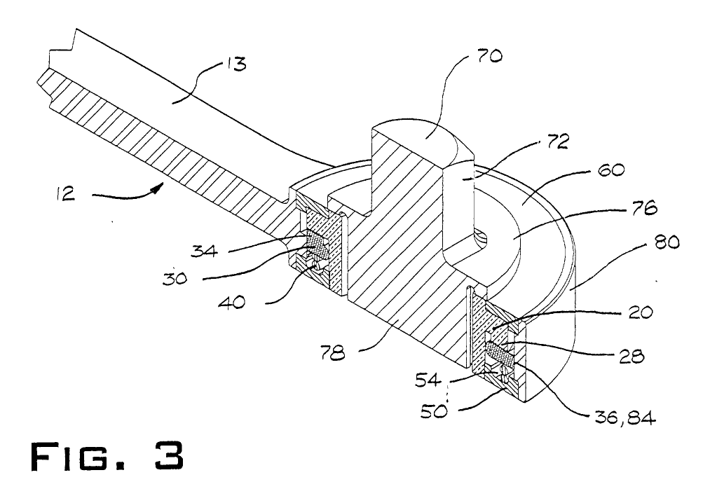

FIGS. 2 and 3 show details of one construction for the wrench 10. A wrench body 12 includes a housing portion 80 on a first end of a handle portion 13. The body 12 may optionally include a non-ratcheting wrench portion 16 on a second end of the handle portion 13 as shown. The housing portion 80 includes a substantially cylindrical opening 82 through the housing 80. In the illustrated embodiment, the axis of the opening is substantially perpendicular to the longitudinal axis of the handle portion 13. As shown in FIGS. 2 and 4, a plurality of axially aligned teeth or splines 84 surround at least a portion of an inner wall of the housing 80 in the inner opening 82. As shown in FIG. 2, the opening 82 is configured to receive a drive member 20, a drive coupling 30, a biasing member or spring 40, a top retainer cover 60, and a bottom retainer cover 50. FIG. 2 also shows an optional socket adapter 70 which may be used with wrench 10 together with conventional sockets (not shown) for using the wrench 10 as a socket wrench as described more fully below. FIG. 3 is a cross-sectional view showing these components assembled together in nested arrangement in the housing 80. The spring 40 may be a coil spring as shown in FIGS. 2, 3, and 7, or alternatively may be a wave spring (not shown). As shown in FIG. 7, a coil spring 40 includes a plurality of turns 44 and a central opening 42.

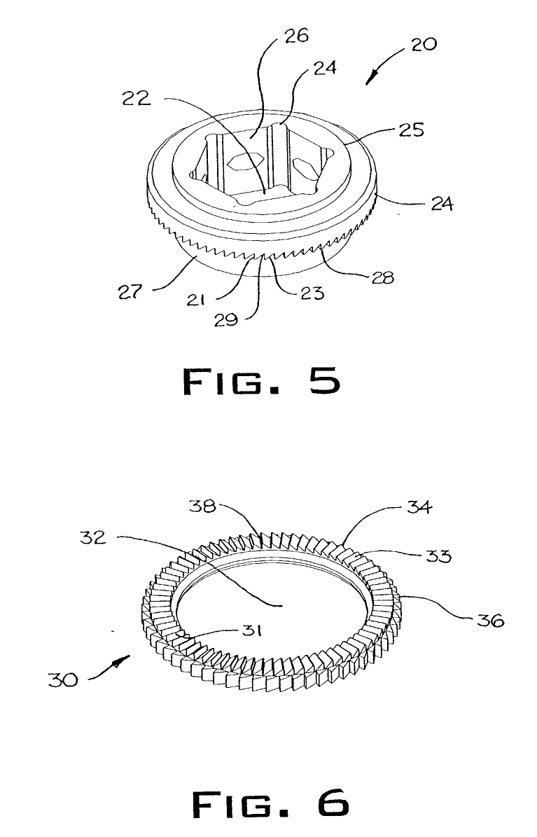

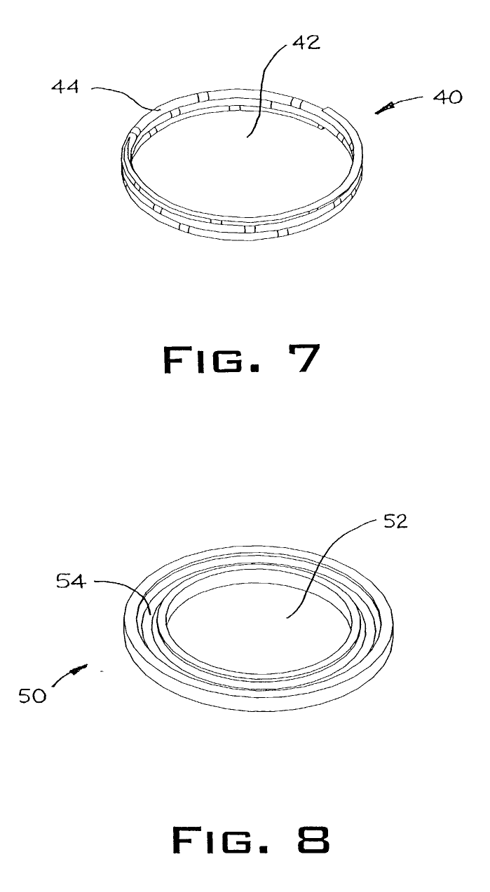

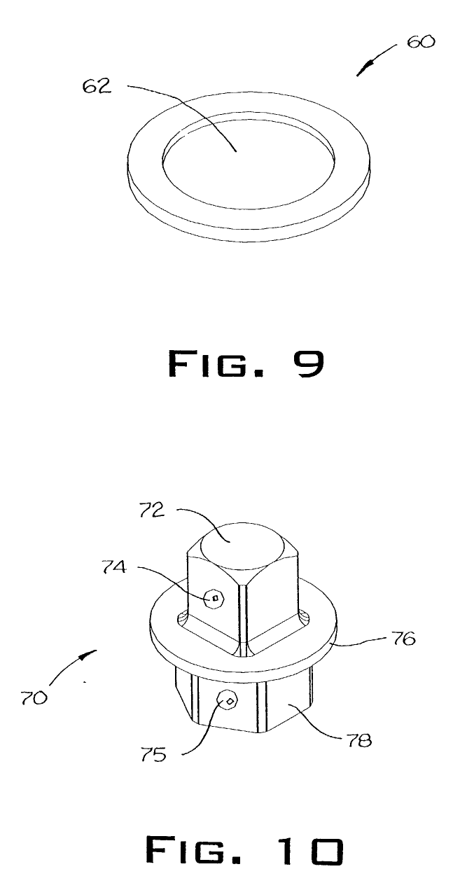

As shown in FIG. 3 and in FIG. 8, the bottom cover 50 may include a circular recess 54 for receiving the spring 40. A ring-shaped drive coupling 30 is positioned adjacent to the spring 40 as shown in FIG. 3. The spring 40 is at least partially compressed between the bottom cover 50 and the drive coupling 30 such that the drive coupling 30 is urged upwardly by the spring 40 when viewed as shown in FIG. 3. The drive coupling 30 includes a plurality of spaced radial teeth 36 around its outer edge as shown in FIGS. 2 and 6. The radial teeth 36 on the drive coupling 30 engage the axial grooves or splines 84 in the housing 80 such that the drive coupling 30 is free to move axially in the housing 80, but is prevented from rotating in the housing 80. The teeth 36 can vary in number and shape. It is only necessary that the teeth 36 permit at least partial axial movement of coupling 30 relative to the inner wall of the housing 80 and prevent rotational movement of the coupling 30 relative to the housing 80. For example, a key and keyway might be used (not shown). Nevertheless, it is preferable to include a plurality of teeth 36 completely around the drive coupling 30 for full 360-degree engagement with the housing 80 to maximize the ability of the interconnection between the coupling 30 and the housing 80 to withstand high torsional loads.

The drive coupling 30 also includes a plurality of spaced drive coupling teeth 34 on a drive coupling drive/ratchet face 38. As shown in FIG. 6, the drive coupling teeth 34 have a substantially “saw tooth” shape and are disposed completely around a central opening 32 in the drive coupling 30. Each of the drive coupling teeth 34 on drive coupling 30 includes a planar driving face 31 that is substantially parallel to the central axis of the drive coupling 30 and is substantially perpendicular to the drive coupling ratchet face 38. Each of the drive coupling teeth 34 also include a planar slip face 33 that intersects the planar driving face 31 at an acute angle.

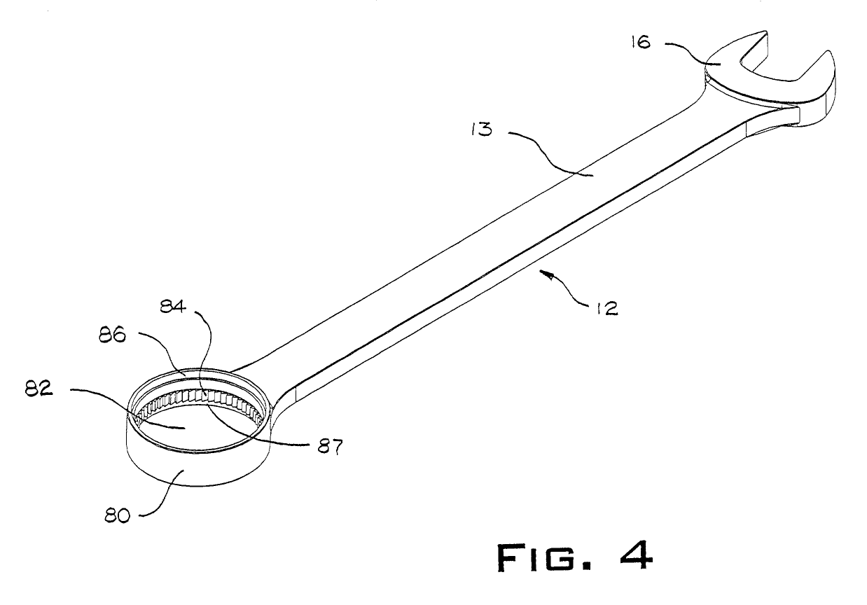

Returning to FIGS. 2 and 3, drive member 20 is positioned adjacent to the drive coupling 30. As shown in FIG. 5, the drive member is substantially circular in shape and includes a hex-receiving aperture 22 therethrough defined by a series of flats 26 and corners 24. The corners 24 may be relieved as shown to provide clearance at the corners 24 when a hex-shaped bolt head, screw head, nut, or the like is received in the aperture 22. A plurality of spaced drive/ratchet teeth 28 are provided on a drive/ratchet face 29. The shape of the drive/ratchet teeth 28 corresponds to the saw-tooth shape of the drive coupling teeth 34 on the drive coupling 30 such that the teeth 28, 34 mesh together when the opposed ratchet faces 29, 38 are forced to intermesh together by the spring 40. As shown in FIG. 5, each of the drive/ratchet teeth 28 on drive member 20 includes a planar driving face 21 that is substantially parallel to the principal axis of the drive member 20 and is substantially perpendicular to the drive/ratchet face 29 of the drive member 20. Each of the drive/ratchet teeth 28 also include a planar slip face 23 that intersects the driving face 21 at an acute angle as shown.

A front cover 60 and back cover 50 partially cover the opening 82 in the housing 80, and retain the spring 40, drive coupling 30, and drive member 20 in the housing 80. A circular opening 62 in the front cover 60 and a circular opening 52 in the back cover 50 are provided to help center the drive member 20 in the housing 80 and to provide access to the hex-receiving aperture 22 in the drive member 20. As shown in FIG. 5, the drive member 20 may include shoulder portions 25, 27. These shoulder portions 25, 27 engage the circular openings 62 and 52 in the front and rear covers 60 and 50, respectively, and thereby rotatably align the drive member 20 in the housing 80. The covers 60, 50 may be pressed or shrunk into the housing 80. Alternatively, snap rings, screws, pins or any other suitable means may be used to affix the covers to the housing (not shown). As shown in FIG. 4, the housing 80 may include recesses 86, 87 to receive the covers 60 and 50, respectively.

In operation, the wrench 10 can be used to either torque or untorque a bolt, screw, nut, or the like. The ratcheting head 14 is engaged on a hex-shaped bolt head, for example, by placing the hex-receiving aperture 22 around the bolt head. In order to accommodate a variety of standard bolt head/nut sizes, a series of ratcheting box wrenches 10 in graduated sizes may be provided in sets. Because the hex-receiving aperture fully extends through the ratcheting head 14, the head of the bolt may be inserted into the hex-receiving aperture 22 from either the front or rear faces of the ratcheting head 14. Accordingly, the wrench 10 can be used to tighten a bolt in a first orientation wherein the drive/ratchet mechanism permits torque to be applied with the wrench 10 in a clockwise rotation (for right-hand threaded bolts, screws, and nuts), and can be used in an opposite orientation (rotated 180 degrees) to loosen a bolt wherein the drive/ratchet mechanism permits torque to be applied with the wrench 10 in a counterclockwise rotation (for right-hand threaded bolts, screws, and nuts).

In either orientation, force is applied manually to the handle portion 13 to produce torque at the ratcheting head 14. Preferably the handle portion 13 is sufficiently long to provide adequate leverage to yield a desired amount of torque. As torque is applied with the wrench 10, the torque is transmitted from the housing 80 to the drive member 20 through the drive coupling 30. The splines 84 in the housing 80 transmit the torque from the housing 80 to the drive coupling 30 through the radial teeth 36 surrounding the drive coupling 30. The spring 40 acts to hold the drive coupling drive/ratchet face 38 against the drive/ratchet face 29 and to maintain meshed engagement between the drive coupling teeth 34 and the drive teeth 28. The torque is transmitted from the drive coupling 30 to the drive member 20 through the meshed teeth 34, 28. When the torque is applied in a direction that causes the drive faces 21, 31 of the drive member 20 and drive coupling 30 to be forced against each other, the drive coupling 30 cannot slip relative to the drive member 20, and torque is transmitted through the drive teeth 34, 28 from the drive coupling 30 to the drive member 20. The torque is then transmitted through the drive member 20 to the bolt head.

Because the drive coupling 30 provides full circumferential engagement with the drive teeth 28 on the drive member 20, the wrench 10 can be used to apply a significantly greater amount of torque than a similarly sized conventional ratcheting box wrench. As discussed above, the pivoting pawls of conventional ratcheting box wrenches provide only limited meshed engagement with the teeth on their drive members, thereby limiting the amount of torque these wrenches can safely withstand. Accordingly, the wrench 10 can be used to apply much higher torque than a comparably sized conventional ratcheting box wrench or ratcheting socket wrench.

In this orientation of the wrench 10, once the bolt head has been at least partially rotated by the applied torque, the handle portion 13 may be swung in a reverse direction without applying substantial reverse torque to the bolt head. As the handle portion 13 is reversed, the inclined planar slip surfaces 23 of the drive teeth 28 wedge against the inclined planar slip surfaces 33 of the drive coupling teeth 34. This wedging action causes the drive coupling teeth 34 to retract from meshed engagement with the drive teeth 28 as the drive coupling 30 is forced to move axially in the housing 80 away from the drive member 20 as the spring 40 is compressed. The spring 40 is sufficiently stiff to hold the drive coupling 30 in selective engagement with the drive member 20 as torque is applied with the wrench 10, but the spring 40 is also sufficiently soft so that it permits the drive coupling 30 to be wedged away from the drive member 20 under the wedging action described above. Accordingly, drive coupling 30, engaged housing 80, and handle 13 can substantially freely rotate together relative to the drive member as the handle 13 is reversed. Once the handle portion 13 is repositioned for an additional torquing stroke, the handle portion 13 can again be reversed to apply additional torque to the bolt head. This action can be repeated a sufficient number of cycles to either fully tighten or loosen the bolt.

To use the wrench 10 to apply torque in an opposite direction from that described above, the wrench 10 can be flipped over 180 degrees (about the longitudinal axis of the handle 13) so that the bolt head is received in the hex-receiving opening 22 from the opposite side of the head 14. In this reversed orientation, the driving and ratcheting motions of the drive coupling 30 are reversed from that described above, and torque can be applied with the wrench 10 in an opposite direction of rotation. Accordingly, the wrench 10 can be used to either tighten or loosen bolts, screws, nuts, or the like by applying substantial torques in either a clockwise or counterclockwise direction of rotation.

The drive member 20, drive coupling 30, and spring 40, as described above, combine to form an exceptionally strong and compact drive/ratcheting mechanism. This compact drive/ratcheting mechanism permits the housing 80 and ratcheting head 14 to also be compact in size, thereby permitting the effective use of ratcheting wrench 10 in limited spaces. Accordingly, this compact, high-torque ratcheting box wrench 10 has a profile that is substantially the same size as a weaker, conventional ratcheting box wrench, and is substantially thinner in profile than comparable socket wrenches.

As shown in FIG. 1, the handle 13 may include a conventional open-end wrench head 16 on an end opposite from the ratcheting box wrench head 14 described above. Alternatively, the wrench head 16 may be a conventional box wrench head (not shown). Where a conventional open-end or box wrench head 16 is included, the wrench head 16 may be sized the same as the aperture 22 in the ratcheting box wrench end 14 for use with bolts, screws, or nuts of the same size.

Optionally, the second end of the handle may include a second ratcheting box wrench head like that described above (not shown). In this configuration of the wrench, it may be preferable that the two ratcheting box wrench heads on opposite ends of the handle are sized differently for use with two different sizes of bolts, screws, or nuts.

The ratcheting box wrench 10 can also be used like a conventional socket wrench. As shown in FIGS. 2, 3, and 10, a socket adapter 70 may be provided to adapt the wrench 10 to receive conventional sockets. As shown in FIG. 10, the socket adapter 70 includes a hex head portion 78, a shoulder 76, and a box member 72. The hex head portion 78 is sized to be securely engaged in the hex-receiving aperture 22 of the wrench 10. The shoulder 76 is provided to prevent the adapter 70 from passing through the aperture 22 when axial loads are applied to the adapter 70. The box member 72 is substantially cubic in shape and is sized to accommodate conventional sockets having mating square openings on their ends. For example, the box member 72 may be sized identically to the drives found on conventional ⅜-inch or ¼-inch drive socket wrenches. Optionally, a ball detent 74 may be provided in at least one side face of the box member 72 to aid in retaining an engaged socket on the box member 72. Also, a second ball detent 75 may be included in at least one flat of the socket head 78 to assist in retaining the socket head 78 in the aperture 22 of the drive member 20. Once a socket is placed on the wrench 10 with adapter 70, the wrench 10 can be used like a conventional socket wrench to tighten a bolt, screw, or nut. If torque must be applied in an opposite direction to loosen a bolt, screw, or nut, the adapter 70 may be flipped over 180-degrees and the socket head 78 may be inserted into the hex-receiving aperture 22 from the opposite side of the wrench 10. Of course, when the wrench 10 as described above is used as a socket wrench in this way, the wrench 10 is capable of withstanding higher torsional loads than a comparably sized conventional ratcheting socket wrench having a conventional drive/ratchet mechanism.

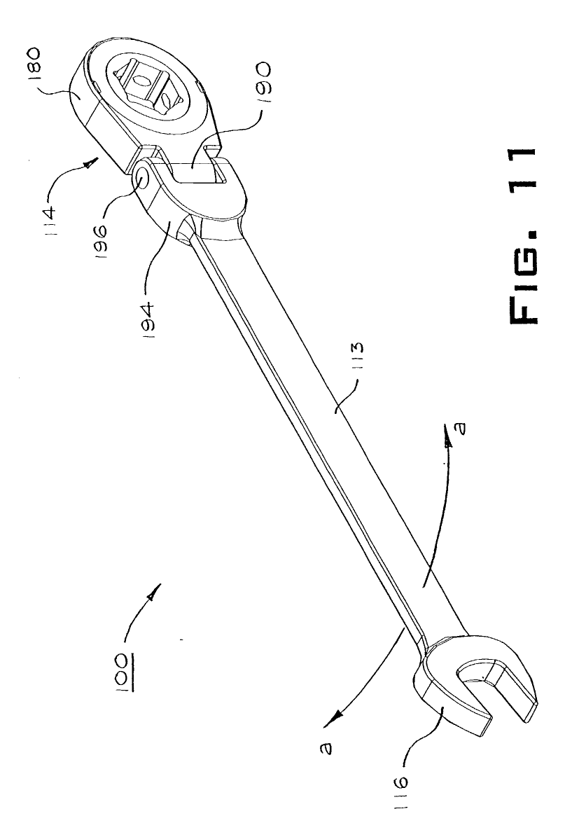

Another embodiment 100 of a ratcheting wrench according to the invention is shown in FIG. 11. In this embodiment, the wrench 100 includes a ratcheting head portion 114 that is substantially the same as the ratcheting head portion 14 of the first embodiment 10 as described above. Unlike the embodiment 10 described above, however, the handle 113 is pivotally connected to the head portion 114. This pivoting connection permits the handle 113 to at least partially pivot out of plane with the housing 180 as indicated by arrows “a” in FIG. 11. In this arrangement, the handle can be pivoted as necessary to avoid surrounding obstructions or to provide additional clearances around the wrench handle 113. The head 114 includes a housing 180 as shown. Though inner portions of the housing 180 are substantially the same as the housing 80 described above with respect to the first embodiment 10, housing 180 includes a tongue portion 190 that extends outwardly from the housing 180. The tongue portion 190 is received in a clevis 194 on one end of the handle 113, and is pivotally connected thereto by a pin 296 that passes through aligned holes in the clevis 294 and the tongue 290. An opposite end of the handle 113 may include a second wrench head 116 as shown. The second wrench head 116 may have an open-end configuration as shown in FIG. 11, or the may be a box-end or ratcheting box-end wrench head (not shown).

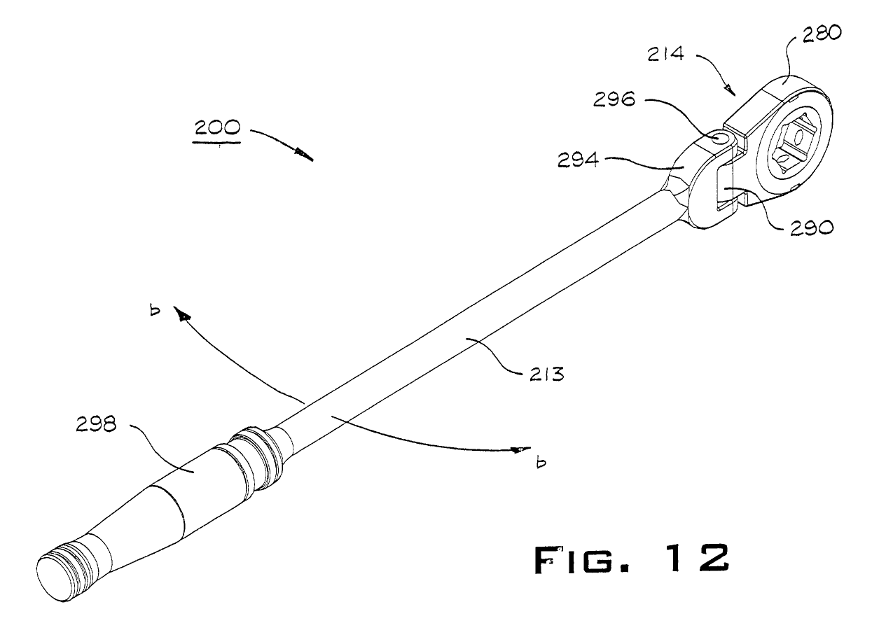

A third embodiment 200 of a ratcheting wrench according to the invention is shown in FIG. 12. Like the second embodiment 100 described above, the wrench 200 includes a head 214 that is pivotally connected to one end of a handle 213 such that the handle 213 can at least partially pivot out of plane with the housing 280 as indicated by arrows “b”. The housing 280 includes a tongue 290 that is received in a clevis 294 on one end of the handle 213. A pin 296 extends through aligned holes in the clevis 294 and tongue 290, thereby pivotally connecting the head 214 to the handle 213. In this arrangement, a long handle 213 is provided with a grip portion 298 on the end of the handle 213 that is opposite the head 214. The elongated handle 213 provides enhanced leverage so that the wrench 200 can be used to apply high torque to a bolt or nut.

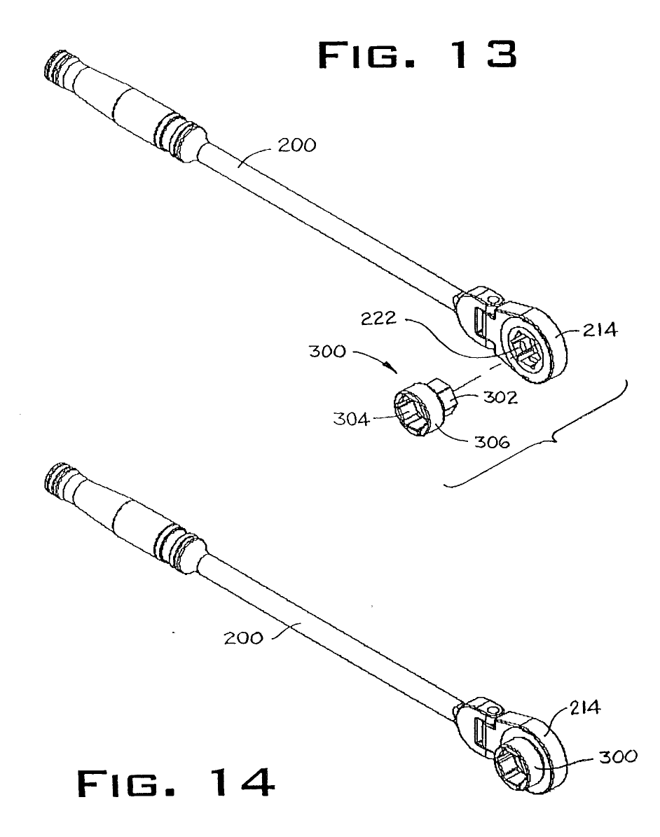

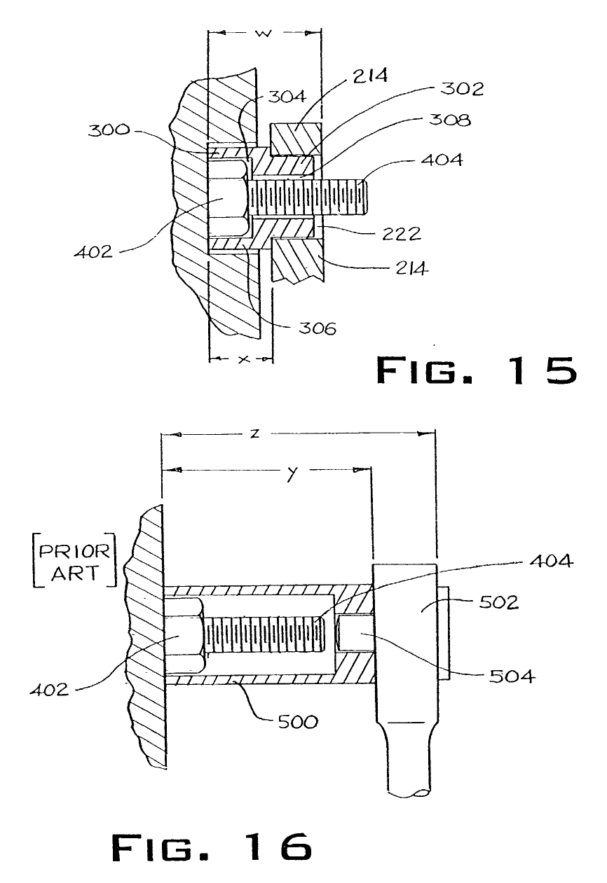

The compact ratcheting wrench 10, 100, 200, as described above, can also be provided with special sockets 300 like that shown in FIGS. 13-15. Though the special socket 300 is shown with embodiment 200 of the wrench, the special socket 300 can also be used in combination with the other described embodiments of the wrench 10, 100. As shown in FIGS. 13 and 15, the special socket 300 includes a male head portion 302 that is sized and shaped to be matingly received in the aperture 222 in the ratcheting head 214. Preferably, the male head portion 302 is hex-shaped. The male head portion 302 can be engaged in the aperture 222 from either side of the wrench head 214 depending on the direction of the torque to be applied with the wrench 200. The special socket 300 also includes a body portion 306 that includes a bolt head-receiving, screw head-receiving, or nut-receiving female opening 304 in an end opposite from the head portion 302. When assembled together as shown in FIG. 14, the wrench 200 and special socket 300 can be used together to tighten or loosen a bolt or nut. The special socket 300 extends outwardly from the face of the wrench 200 by a distance “x” as shown in FIG. 15. This permits the wrench 200 to be used to tighten or loosen a bolt head, screw head or nut that is recessed in a counterbore, a recess, or the like, and that otherwise may be inaccessible with the wrench 200 if used alone. The length “x” of the body portion 306 can be varied as desired, but is preferably short to permit the wrench 200 and special socket 300 combination to be compact in combined height. As shown in FIG. 15, the special socket 300 may include a bore 308 that extends through the male head portion 302. The bore 308 provides clearance for an elongated threaded shaft 402 of a bolt or stud such that the shaft can extend through the bore 308 and the aperture 222 in the wrench head 214. This clearance permits the body portion 306 to reach and engage a nut 404 that is engaged on a protruding threaded shaft 402 as shown.

The special socket 300 permits the high-torque ratcheting wrench 10, 100, 200 as described above to be used like a socket wrench while maintaining an exceptionally compact overall outer profile. Because the head portion 302 is recessed into the aperture 222 of the wrench head 214 when the wrench and special socket 300 are assembled together as shown in FIG. 15, the overall height of the wrench/socket assembly is “w.” This height “w” is less than the combined individual heights of the wrench head 214 and socket 300. A comparison of FIGS. 15 and 16 illustrates that the overall height “w” of the wrench/socket combination is necessarily shorter than the corresponding combined height “z” of a comparable conventional socket wrench/socket combination 500/502. This shorter height is due in part to the fact that the protruding box drive member 504 on a conventional socket wrench 502 necessarily occupies additional length in the combination (see FIG. 16).

The bore 308 extending through the special socket 300 as shown in FIG. 15 further permits the special socket 300 to be much shorter in overall length than a comparable conventional socket 500. As shown in FIG. 16, a conventional socket 500 is typically constructed with an extended length “y” to permit the socket 500 to receive at least a portion of a protruding threaded shaft 404 so that the socket 500 can reach and engage a nut 402 that is engaged on the shaft 404. As a result, the combined height “z” of the conventional socket wrench 502 and socket 500 is necessarily much greater than the compact height “w” of the present invention. Accordingly, when the special socket 300 is used in combination with the high-torque ratcheting wrench 10, 100, 200, it yields a ratcheting socket wrench that is substantially more compact in profile than a comparable conventional socket wrench/socket combination. This compact configuration permits a wrench/socket combination 200/300 according to the present invention, as shown in FIG. 14, to be used in much more confined areas than a comparable conventional socket/wrench. The special sockets 300 can be provided in sets in graduated sizes to permit a single wrench 200 having a fixed-size aperture 222 to be used to tighten or loosen nuts, screws, bolts, and the like in a wide range of standard bolt, screw, and nut sizes.

The above detailed description is limited to certain specific embodiments of the invention for the purposes of conciseness and readability. Those of ordinary skill in the art will recognize that certain modifications may be made to the described embodiments without departing from the scope of the invention. Such modifications are intended to be within the scope of the appended claims.

What is claimed is:

1. A ratcheting box wrench comprising:
(a) a housing on a first end of a wrench handle, the housing having a housing opening therethrough having a central axis;
(b) a drive member having a front face and a rear face, the drive member being rotatably mounted in the housing opening, having a nut-receiving or head-receiving aperture therethrough, and having a plurality of drive teeth disposed completely around the aperture;
(c) a drive coupling engaged in the housing such that the drive coupling is capable of at least partial axial movement in the housing but is restrained against rotation relative to the housing, the drive coupling having a plurality of drive coupling teeth that are disposed completely around a central opening and that selectively mesh with the plurality of drive teeth on the drive member;
(d) a spring that biases the drive coupling toward the drive member such that the plurality of drive teeth and the plurality of drive coupling teeth are resiliently held together in meshed engagement by the spring;
wherein the plurality of drive teeth and the plurality of drive coupling teeth have compatible tooth shapes such that the drive coupling teeth cooperate to prevent relative rotation between the drive member and the housing in a first direction of rotation when the drive teeth and drive coupling teeth are engaged together, and wherein the plurality of drive teeth and the plurality of drive coupling teeth cooperate to cause the drive coupling teeth and drive teeth to resiliently disengage from each other as the drive member is rotated relative to the housing in an opposite second direction of rotation, thereby permitting substantially free rotation of the drive member relative to the housing in the second direction of rotation.

2. A ratcheting box wrench according to claim 1 wherein each of the drive coupling teeth on the drive coupling and each of the drive teeth on the drive member have substantially planar drive faces that are substantially parallel to the central axis of the opening in the housing.

3. A ratcheting box wrench according to claim 2 wherein each of the drive coupling teeth on the drive coupling and each of the drive teeth on the drive member have a substantially planar slip face that intersects an adjacent drive face at an acute angle.

4. A ratcheting box wrench according to claim 1 wherein the nut-receiving or head-receiving aperture is capable of receiving a nut or head from either the front face or the rear face of the drive member.

5. A ratcheting box wrench according to claim 1 further comprising a socket adapter having a first end with a male head portion configured to be matingly received in the nut-receiving or head-receiving aperture in the drive member, and having a second end with a box member configured for engagement with a square end of a compatibly sized socket.

6. A ratcheting box wrench according to claim 1 wherein the handle includes a second end and further comprising an open-end or box-end wrench head on the second end of the handle.

7. A ratcheting box wrench according to claim 1 wherein the handle includes a second end and further comprising a ratcheting box wrench head on the second end of the handle.

8. A ratcheting box wrench according to claim 1 wherein the housing is pivotally connected to the first end of the wrench handle such that the handle can be pivoted out of plane with the housing.

9. A ratcheting box wrench according to claim 1 further comprising a special socket, the special socket comprising:
(a) a body portion having a male end and a female end, the female end including a nut-receiving or head-receiving opening therein; and
(b) a socket head on the male end of the body, the socket head being shaped and sized to be matingly engaged in the nut-receiving or head-receiving aperture in the drive member.

10. A ratcheting box wrench according to claim 9 wherein the socket head on the male end of the body of the special socket includes a bore therethrough, the bore being in communication with the nut-receiving or head-receiving opening in the female end of the body.

11. A ratcheting box wrench comprising:
(a) a housing having an inner wall including a plurality of axial teeth or splines thereon;
(b) an elongated handle having a first end connected to the housing and a second end;
(c) a drive member rotatably mounted in the housing, the drive member including a central aperture therethrough and a drive ratchet face comprising a plurality of drive teeth, the aperture being shaped to matingly receive a nut or a head of a bolt or screw;
(d) a substantially ring-shaped drive coupling having a central axis, a plurality of radial teeth completely therearound that are in meshed engagement with the axial teeth or splines on the inner wall of the housing, and a drive coupling ratcheting face having a plurality of drive coupling teeth configured for selective meshed engagement with the drive teeth on the drive member, wherein the radial teeth on the drive coupling cooperate with the axial teeth or splines in the housing to permit at least partial axial movement of the drive coupling in the housing while preventing relative rotational displacement of the drive coupling in the housing;
(e) a biasing member that resiliently holds the drive coupling teeth of the drive coupling in selective engagement with the drive teeth of the drive member;
wherein the drive coupling teeth meshingly engage the drive teeth of the drive member and thereby permit substantial torque to be applied to the nut or head with the wrench in a first direction of rotation, and wherein the drive coupling teeth and drive teeth cooperate to automatically selectively disengage from each other and permit substantially free relative rotation between the drive member and the housing when torque is applied with the wrench to the nut or head in an opposite second direction of rotation .

12. A ratcheting box wrench according to claim 11 wherein the biasing member is a coil spring.

13. A ratcheting box wrench according to claim 11 wherein the biasing member is a wave spring.

14. A ratcheting box wrench according to claim 11 wherein the drive member includes a front face and a rear face, and wherein a nut or head of a bolt or screw can be received in the central aperture of the drive member from either the front face or the rear face.

15. A ratcheting box wrench according to claim 14 wherein the wrench is capable of applying a substantial torque to the nut or head in the first rotational direction when the nut or head is received in the central aperture of the drive member from the front face, and wherein the wrench is capable of applying a substantial torque to the nut or head in the second rotational direction when the nut or head is received in the central aperture of the drive member from the rear face.

16. A ratcheting box wrench according to claim 11 wherein the central aperture in the drive member has a shape that provides a plurality of circumferentially spaced recesses for receiving corners of a nut or head when the nut or head is received in the aperture.

17. A ratcheting box wrench according to claim 15 wherein the number of circumferentially spaced recesses provided by the shape of the aperture is a multiple of six.

18. A ratcheting box wrench according to claim 11 wherein each of the drive coupling teeth includes a substantially planar drive surface that is substantially parallel to the central axis of the drive coupling, and a substantially planar slip surface arranged at an acute angle with the substantially planar first surface.

19. A ratcheting box wrench according to claim 11 further comprising a socket adapter having a first end configured to be matingly received in the central aperture in the drive member, and having a second end with a box member configured to securely engage one end of a compatibly sized socket.

20. A ratcheting box wrench according to claim 11 further including an open-end or box wrench head on the second end of the handle.

21. A ratcheting box wrench according to claim 11 further including a ratcheting box wrench head on the second end of the handle.

22. A ratcheting box wrench according to claim 11 wherein the first end of the elongated handle is pivotally connected to the housing such that the handle can be at least partially pivoted out of plane with the housing.

23. A ratcheting box wrench according to claim 11 further comprising a special socket, the special socket comprising:
(a) a body portion having a male end and a female end, the female end including a nut-receiving or head-receiving opening therein; and
(b) a socket head on the male end of the body, the socket head being shaped and sized to be matingly engaged in the nut-receiving or head-receiving aperture in the drive member.

24. A ratcheting box wrench according to claim 23, wherein the socket head on the male end of the body includes a bore therethrough, the bore being in communication with the nut-receiving or head-receiving opening in the female end of the body.

25. A drive/ratchet mechanism for a box wrench, the mechanism comprising:
(a) a drive member including a nut or head-receiving aperture therethrough, and a plurality of circumferentially spaced drive teeth on a drive ratchet surface, the drive teeth being substantially evenly spaced completely around the aperture;
(b) a substantially ring-shaped drive coupling axially aligned with the drive member and including a central opening therethrough and a plurality of circumferentially spaced drive coupling teeth on a drive coupling ratchet surface, the drive coupling teeth being substantially evenly spaced completely around the central opening; and
(c) a spring that resiliently biases the drive coupling against the drive member such that the drive coupling teeth and drive teeth-selectively intermesh together;
wherein the drive teeth and drive coupling teeth are configured to substantially prevent relative rotational displacement between the drive member and drive coupling when the drive member is rotated in a first direction relative to the drive coupling, and wherein the drive teeth and drive coupling teeth are configured to cooperate and cause the drive coupling to be resiliently pushed away from the drive member and thereby cause the drive coupling teeth to disengage from the drive teeth on the drive member as the drive member is rotated in an opposite second direction of rotation relative to the drive coupling, thereby permitting substantially free rotation of the drive member relative to the drive coupling in the second direction of rotation.
